(19) United States
(12) Patent Application Publication
(10) Pub. No.: US 2011/0261170 A1
(43) Pub. Date: Oct. 27, 2011

(54) VIDEO DISPLAY APPARATUS AND VIDEO DISPLAY METHOD

(75) Inventor: Shogo MATSUBARA, Tokyo (JP)

(73) Assignee: Kabushiki Kaisha Toshiba, Tokyo (JP)

(21) Appl. No.: 13/015,409

(22) Filed: Jan. 27, 2011

(30) Foreign Application Priority Data
Apr. 27, 2010 (JP) 2010-102760

(51) Int. Cl. H04N 13/04

(52) U.S. Cl. 348/51; 348/E13.075

(57) ABSTRACT

According to one embodiment, there is provided a video display apparatus, including: a 3D image generating module configured to receive a 3D image input signal; and to generate a 3D image display signal to be displayed on a screen of a video display unit, from the 3D image input signal; and an image mixing module configured to receive a 2D image signal and the 3D image display signal; to mix the 3D image display signal to be displayed on a first area of the screen and the 2D image signal to be displayed on a second area of the screen to generate a mixed image signal, the first area being different from the second area; and to output the mixed image signal to the video display unit.

### CROSS-REFERENCE TO RELATED APPLICATION(S)

This application is based upon and claims the benefit of priority from Japanese Patent Application No. 2010-102760, filed on Apr. 27, 2010, the entire contents of which are incorporated herein by reference.

### FIELD

Embodiments described herein relate generally to a video display apparatus and a video display method for displaying a 2D image and a 3D image.

### BACKGROUND

Current video display apparatus allow a viewer to view 3D video by displaying, on the display screen, a 3D image that consists of a right-eye image and a left-eye image having a parallax. Such video display apparatus employs a 3D image selecting module that causes only the right-eye image of the 3D image to reach the right eye of the viewer and causes only the left-eye image to reach the left-eye of the viewer. For example, the 3D image selecting module may be glasses such as circularly polarization glasses in which a right-eye lens and a left-eye lens transmit circularly polarized light beams having different rotation directions or liquid crystal shutter glasses in which a right-eye lens and a left-eye lens are alternately rendered in a transparent state or an opaque state. Video display apparatus generate and display a 3D image compatible with the 3D image selecting module.

If a 3D image for the parallax division method is directly displayed, two images that are slightly deviated from each other are displayed alternately, and an unnatural feeling will be caused. As a countermeasure, for example, in JP-2005-318421-A, stereographic pair images are output so that a right-eye image and a left-eye image are displayed on the left side and the right side, respectively.

However, in conventional video display apparatus, if the 3D image selecting module is not used, a 3D image is recognized as a double image of a right-eye image and a left-eye image, and it cannot be viewed properly. That is, the use of the 3D image selecting module is indispensable. When plural viewers exist, an enough number of the 3D image selecting modules might not be available. In this case, a part of viewers not using the 3D image selecting module cannot view a 3D image simultaneously with the other part of viewers using the 3D image selecting module. No module for enabling simultaneous viewing by plural viewers is known.

### BRIEF DESCRIPTION OF THE DRAWINGS

A general architecture that implements the various feature of the present invention will be described with reference to the drawings. The drawings and the associated descriptions are provided to illustrate embodiments of the present invention and not to limit the scope of the present invention.

FIG. 1 illustrates a digital TV broadcast receiver 111 according to the embodiments and a network system centered by the digital TV broadcast receiver 111.

FIG. 2 illustrates a signal processing system of the digital TV broadcast receiver 111.

FIG. 3 illustrates a block configuration of a video display apparatus according to a first embodiment which has a first configuration.

FIG. 4 illustrates an advantage of the first embodiment.

FIG. 5 illustrates a block configuration of a video display apparatus according to a second embodiment which has a second configuration.

FIG. 6 illustrates a block configuration of a video display apparatus according to a third embodiment which has a second configuration.

FIG. 7 illustrates a block configuration of a video display apparatus according to a fourth embodiment which has a second configuration.

FIG. 8 illustrates a block configuration of a conventional video display apparatus.

FIG. 9 illustrates a problem of the conventional video display apparatus.

### DETAILED DESCRIPTION

In general, according to one embodiment, there is provided a video display apparatus, including: a 3D image generating module configured to receive a 3D image input signal; and to generate a 3D image display signal to be displayed on a screen of a video display unit, from the 3D image input signal; and an image mixing module configured to receive a 2D image signal and the 3D image display signal; to mix the 3D image display signal to be displayed on a first area of the screen and the 2D image signal to be displayed on a second area of the screen to generate a mixed image signal, the first area being different from the second area; and to output the mixed image signal to the video display unit.

Embodiments will be described below.

### First Embodiment

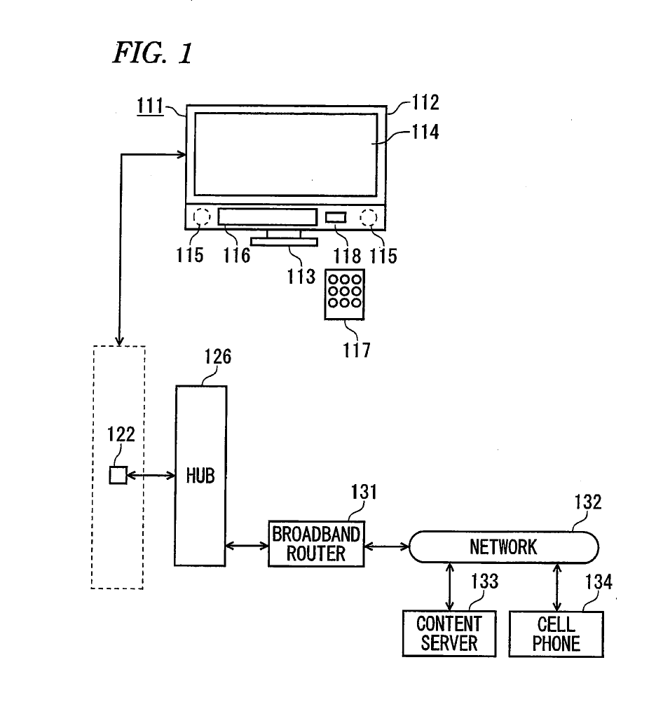

A first embodiment will be hereinafter described with reference to FIGS. 1-4, 8, and 9.

FIG. 1 illustrates a digital TV broadcast receiver 111 as a video display apparatus according to the embodiments and an example network system centered by the digital TV broadcast receiver 111.

The digital TV broadcast receiver 111 has a thin cabinet 112 and a support stage 113 for supporting the cabinet 112 in a erected posture. The cabinet 112 is equipped with a flat panel video display 114 such as a liquid crystal display panel, speakers 115, an manipulation unit 116, a light receiving unit 118 for receiving manipulation information that is transmitted from a remote controller 117, and other units.

The digital TV broadcast receiver 111 is also equipped with a LAN (local area network) terminal 122. The LAN terminal 122 is connected to a network 132 such as the Internet via a broadband router 131 connected to a hub 126. The LAN terminal 122 is used for exchanging information with a content server 133, a cell phone 134, or the like over the network 132.

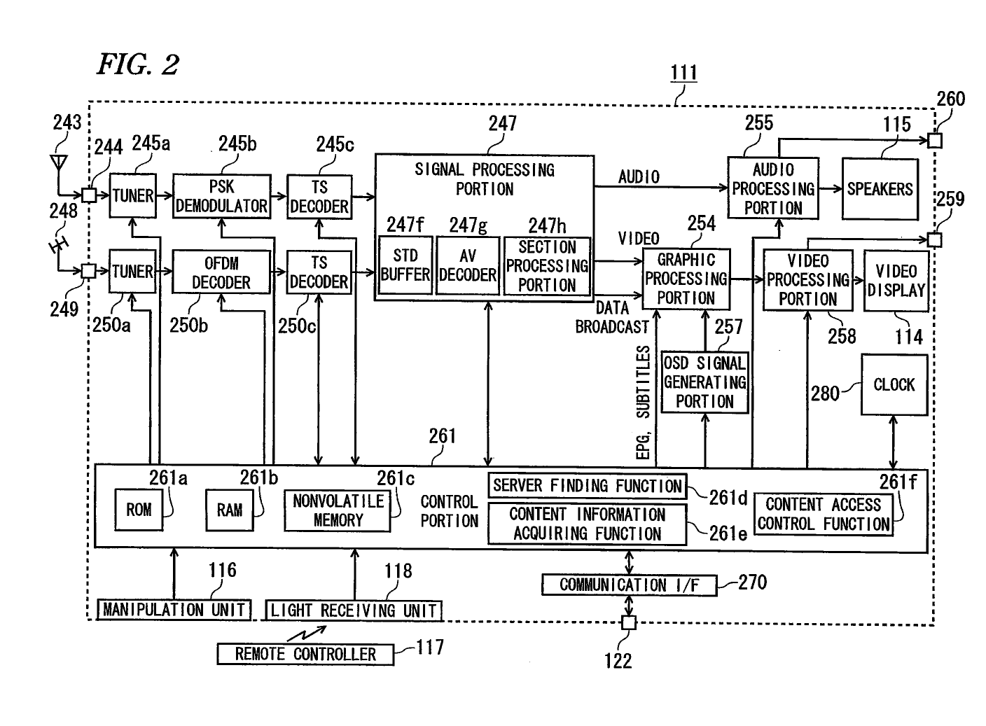

FIG. 2 illustrates a signal processing system of the digital TV broadcast receiver 111.

Satellite digital TV broadcast signals received by a BS/CS digital broadcast receiving antenna 243 are supplied to a satellite digital broadcast tuner 245a via an input terminal 244.

The tuner 245a tunes into a broadcast signal on a desired channel according to a control signal supplied from a control portion 261 and supplies the thus-selected broadcast signal to a PSK (phase shift keying) demodulator 245b.

The PSK demodulator 245b demodulates, according to a control signal supplied from a control portion 261, the broadcast signal selected by the tuner 245a into a transport stream (TS) containing a desired program and supplies the transport stream to a TS decoder 245c.

The TS decoder 245c performs TS decoding on the TS-multiplexed signal according to a control signal supplied from a control portion 261 and thereby depacketizes it into a digital video signal and a digital audio signal of the desired program, and outputs resulting packetized elementary streams (PESs) to an STD buffer 247f provided in a signal processing portion 247.

The TS decoder 245c outputs, to a section processing portion 247h provided in the signal processing portion 247, section information that is transmitted by the digital broadcast.

Terrestrial digital TV broadcast signals received by a terrestrial broadcast receiving antenna 148 are supplied to a terrestrial digital broadcast tuner 250a via an input terminal 249.

The tuner 250a tunes into a digital broadcast signal on a desired channel according to a control signal supplied from the control portion 261 and supplies the thus-selected broadcast signals to an OFDM (orthogonal frequency division multiplexing) demodulator 250b.

The OFDM demodulator 250b demodulates, according to a control signal supplied from the control portion 261, the broadcast signal selected by the tuner 250a into transport stream containing a desired program and supplies the transport stream to a TS decoder 250c.

The TS decoder 250c performs TS decoding on the TS-multiplexed signal according to a control signal supplied from the control portion 261 and thereby depacketizes it into a digital video signal and a digital audio signal of the desired program, and outputs resulting packetized elementary streams (PESs) to the STD buffer 247f provided in the signal processing portion 247.

The TS decoder 250c outputs, to the section processing portion 247h provided in the signal processing portion 247, section information that is transmitted by the digital broadcast.

While a TV broadcast is being viewed, the signal processing portion 247 selectively performs given signal processing on a digital video signal and a digital audio signal supplied from the TS decoders 245c and 250c, respectively, and outputs a resulting video signal and audio signal to a graphic processing portion 254 and an audio processing portion 255, respectively. During content reproduction, the signal processing portion 247 selects a content reproduction signal that is input from the control portion 261, performs given digital signal processing on it, and outputs a resulting video signal and audio signal to the graphic processing portion 254 and the audio processing portion 255, respectively.

Various data for acquiring a program, electronic program guide (EPG) information, program attribute information (program genre etc.), and subtitle information etc. (service information, SI, or PSI) are input to the control portion 261 from the signal processing portion 247.

The control portion 261 performs image generation processing for displaying an EPG or subtitles based on these kinds of received information, and outputs generated information to a graphic processing portion 254.

The section processing portion 247h outputs, to the control portion 261, various data for acquiring a program, electronic program guide (EPG) information, program attribute information (program genre etc.), and subtitle information etc. (service information, SI, or PSI) which are part of section information input from the TS decoder 245c or 250c.

The graphic processing portion 254 has a function of combining (1) a digital video signal that is supplied from an AV decoder 247g provided in the signal processing portion 247, (2) an OSD signal generated by an OSD (on-screen display) signal generating portion 257, (3) image data of a data broadcast, and (4) an EPG or subtitle signal generated by the control portion 261 and outputting a resulting signal to the video processing portion 258.

In displaying subtitles of a subtitle broadcast, the graphic processing portion 254 performs processing of superimposing, on a video signal, subtitle information that is supplied from the control portion 261.

The digital video signal that is output from the graphic processing portion 254 is supplied to a video processing portion 258. The video processing portion 258 converts the received digital video signal into an analog video signal having a format displayable by the video display 114. The analog video signal is output to and displayed by the video display 114 and also output to the outside via an output terminal 259.

The audio processing portion 255 converts the received digital audio signal into an analog audio signal having a format reproducible by the speakers 115. The analog audio signal is output to and reproduced as a sound by the speakers 115 and also output to the outside via an output terminal 260.

The control portion 261 supervises all operations of the digital TV broadcast receiver 111 including various receiving operations described above. The control portion 261 includes a CPU (central processing unit) etc., and controls the individual portions based on manipulation information supplied from the manipulation unit 116 or the remote controller 117 (via the light receiving unit 118) so as to reflect the content of the manipulation.

In doing to, the control portion 261 uses a ROM (read-only memory) 261a which is stored with control programs to be run by the CPU, a RAM (random access memory) 261b for providing a work area for the CPU, and a nonvolatile memory 261c which is stored with various kinds of setting information, control information, etc.

The control portion 261 is connected to the LAN terminal 122 via a communication interface (I/F) 270. The control portion 261 can thus exchange information, via the communication I/F 270, with each apparatus connected to the LAN terminal 122 (see FIG. 1).

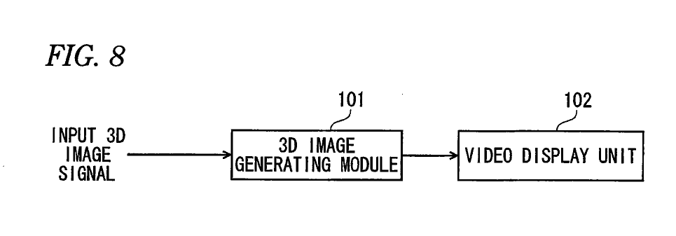

The configuration of a conventional video display apparatus will now be described. As shown in FIG. 8, the conventional video display apparatus has a video display unit 102 and a 3D image generating module 101 for generating a 3D image according to a display method of the video display unit 102. The video display unit 102 displays an output of the 3D image generating module 101 and allows a viewer to view 3D video with a 3D image selecting module that causes only a right-eye image of the 3D image to reach the right eye of the viewer and causes only a left-eye image to reach the left-eye of the viewer. For example, the 3D image selecting module may be glasses such as circularly polarization glasses in which a right-eye lens and a left-eye lens transmit circularly polarized light beams having different rotation directions or liquid crystal shutter glasses in which a right-eye lens and a left-eye lens are alternately rendered in a transparent state or an opaque state. Video display apparatus generate and display a 3D image compatible with the 3D image selecting module. The 3D image generating module 101 generates a 3D image compatible with a combination of the video display unit 102 and the 3D image selecting module. For example, the 3D image generating module 101 arranges a right-eye image and a left-eye image side by side or according to the arrangement of circularly polarizing sheets stuck to the front surface of the video display unit 102 or outputs a right-eye image and a left-eye image alternately in synchronism with the opening/closing timing of the liquid crystal shutter glasses.

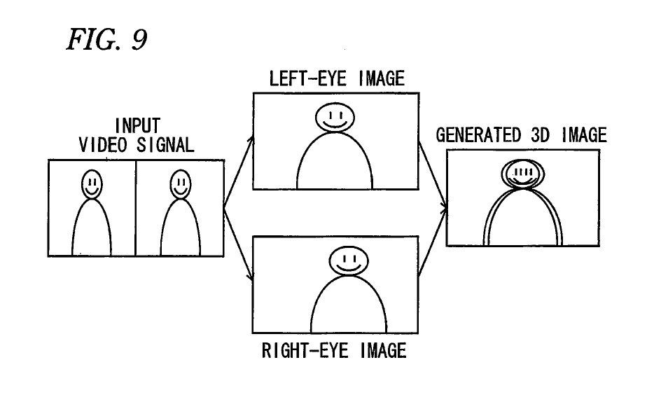

In the conventional video display apparatus, as shown in FIG. 9, if the 3D image selecting module is not used, a 3D image is recognized as a double image of a right-eye image and a left-eye image, that is, it cannot be viewed properly. The use of the 3D image selecting module is indispensable and viewer(s) not using the 3D image selecting module cannot view a 3D image simultaneously with viewer(s) using the 3D image selecting module.

In the embodiment, a video display apparatus is provided which allows plural viewers to view same-contents images simultaneously irrespective of whether the 3D image selecting module is used or not by simultaneously displaying a stereoscopically-viewable 3D image and an ordinary 2D image recognizable without using the 3D image selecting module.

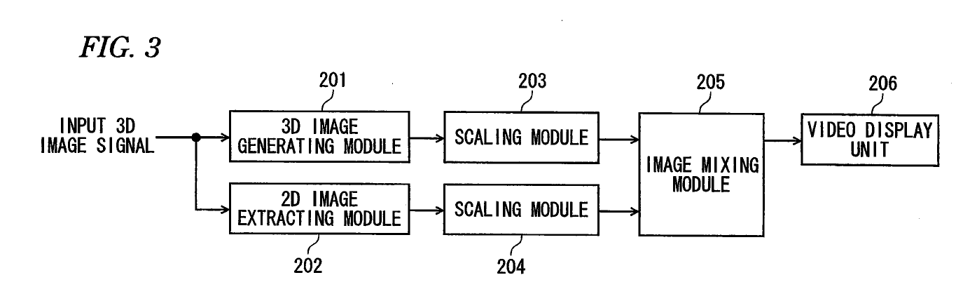

A video display apparatus having a first configuration according to the first embodiment will be described below. As shown in FIG. 3, the video display apparatus has a 3D image generating module 201 for generating a 3D image from an input 3D image signal according to a display method of a video display unit 206, a 2D image extracting module 202 for extracting, from the input 3D image signal, information that can be viewed as a 2D image, scaling modules 203 and 204 for converting the sizes of the generated 3D image and the extracted 2D image into desired sizes, respectively, an image mixing module 205 for mixing resulting size-converted images into a single image, and the video display unit 206 for displaying the image generated by the image mixing module 205.

Next, a description will be made of how the video display apparatus having the configuration of FIG. 3 operates. An input 3D image signal (an image signal containing 3D image information) is input to the 3D image generating module 201, which generates a 3D image compatible with a combination of the video display unit 206 and the 3D image selecting module. The input 3D image signal is also input to the 2D image extracting module 202, which extracts information that can be viewed as a 2D image from it. For example, in the side-by-side method in which a single 3D image is generated by arranging a right-eye 2D image and a left-eye 2D image each having a size half the screen size on the left side and the right side, respectively, the 2D image extracting module 202 selects one of the right-eye 2D image and the left-eye 2D image. Where the input 3D image signal consists of a 2D image and depth information, the 2D image extracting module 202 outputs only the 2D image (i.e., excludes the depth information). The thus-generated 3D image and 2D image are input to the respective scaling modules 203 and 204, which convert their sizes into desired sizes. Resulting images are mixed together by the image mixing module 205 into a single display image to be displayed by the video display unit 206. The conversion-result image sizes and the arrangement of images in a mixed image can be set arbitrarily. Images in a mixed image may overlap with each other.

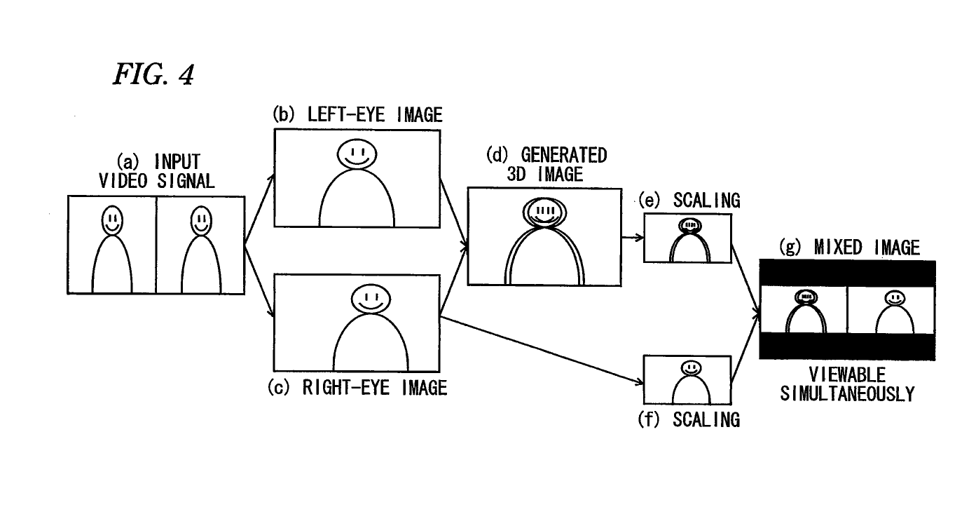

FIG. 4 illustrates an advantage of the above configuration. As illustrated in FIG. 4, a left-eye image (b) and a right-eye image (c) are separated from an input 3D image signal (a). And, an image (e) obtained by scaling a 3D image (d) which is generated from the separated images and is stereoscopically-viewable and a scaled 2D image (f) having the same contents as the former are displayed simultaneously (g). Therefore, plural viewers can view the mixed image simultaneously irrespective of whether or not they use the 3D image selecting module.

The 3D image and the 2D image need not always be arranged side by side and may be arranged in different manners. The scaling modules 203 and 204 may perform size conversion into different sizes.

### Second Embodiment

Next, a second embodiment will be described with reference to FIGS. 1, 2, and 5. The same module etc. as in the first embodiment will not be described in detail.

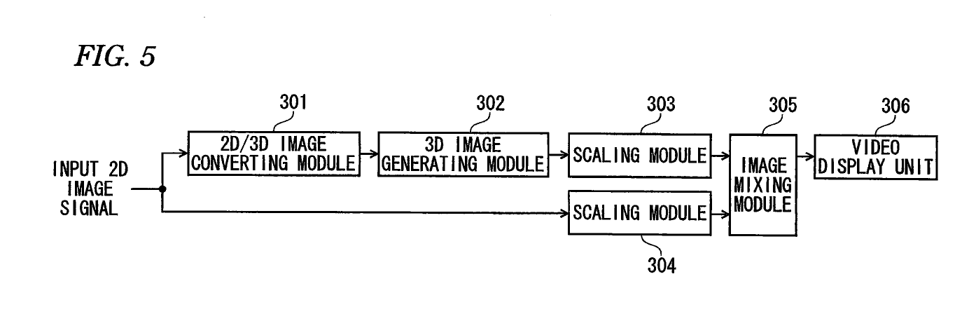

A video display apparatus having a second configuration according to the second embodiment will be described below. As shown in FIG. 5, the video display apparatus has a 2D/3D image converting module 301 for generating a 3D image signal from an input 2D image signal, a 3D image generating module 302 for generating a 3D image from the generated 3D image signal according to a display method of a video display unit 306, scaling modules 303 and 304 for converting the sizes of the generated 3D image and the input 2D image into desired sizes, respectively, an image mixing module 305 for mixing resulting size-converted images into a single image, and the video display unit 306 for displaying the image generated by the image mixing module 305.

Next, a description will be made of how the video display apparatus having the configuration of FIG. 5 operates. An input 2D image signal is input to the 2D/3D image converting module 301, which generates a 3D image signal for viewing of a 3D image by, for example, calculating depth information through pattern matching based on motion information or image features. The generated 3D image signal is input to the 3D image generating module 302, which generates a 3D image compatible with a combination of the video display unit 306 and the 3D image selecting module. The generated 3D image and the input 2D image are input to the respective scaling modules 303 and 304, which convert their sizes into desired sizes. Resulting images are mixed together by the image mixing module 305 into a single display image to be displayed by the video display unit 306. The conversion-result image sizes and the arrangement of images in a mixed image can be set arbitrarily. This configuration provides the same advantage as the first configuration.

(Third Configuration)

Next, a third embodiment will be described with reference to FIGS. 1, 2, and 6. The same module etc. as in the first or second embodiment will not be described in detail.

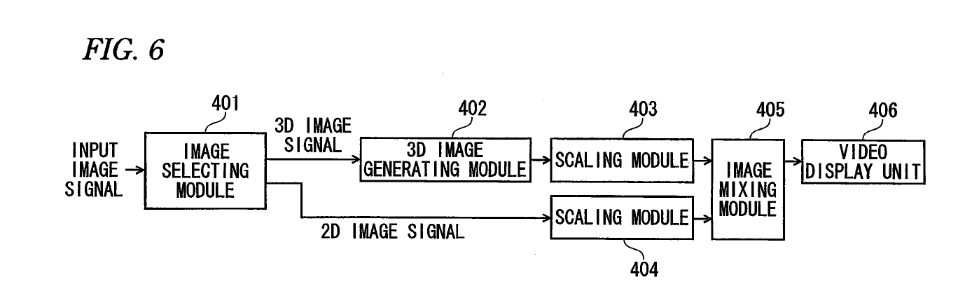

A video display apparatus having a third configuration according to the third embodiment will be described below. As shown in FIG. 6, the video display apparatus has an image selecting module 401 for separating a 2D image signal and a 3D image signal from data containing both of a 2D image signal and a 3D image signal having the same contents, a 3D image generating module 402 for generating a 3D image from the separated 3D image signal according to a display method of a video display unit 406, scaling modules 403 and 404 for converting the sizes of the generated 3D image and the separated 2D image into desired sizes, respectively, an image mixing module 405 for mixing resulting size-converted images into a single image, and the video display unit 406 for displaying the image generated by the image mixing module 405.

Next, a description will be made of how the video display apparatus having the configuration of FIG. 6 operates. For example, in future, when recording TV broadcast, both of a 2D image signal and a 3D image signal may be recorded into a recording medium to allow a viewer to select the 2D image signal or the 3D image signal depending on their environment. For example, in such case, the image selecting module 401 acquires both of a 2D image signal and a 3D image signal and passes them to the downstream processing module after separating them from each other. The 3D image signal is input to the 3D image generating module 402, which generates a 3D image compatible with a combination of the video display unit 406 and the 3D image selecting module. The generated 3D image and the separated 2D image are input to the respective scaling modules 403 and 404, which convert their sizes into desired sizes. Resulting images are mixed together by the image mixing module 405 into a single display image to be displayed by the video display unit 406. The conversion-result image sizes and the arrangement of images in a mixed image can be set arbitrarily. This configuration provides the same advantage as the first configuration.

### Fourth Embodiment

Next, a fourth embodiment will be described with reference to FIGS. 1, 2, and 7. The same module etc. as in the first, second or third embodiment will not be described in detail.

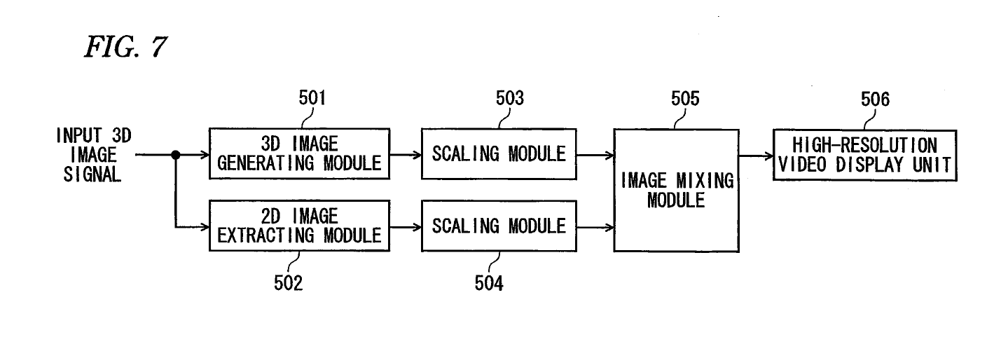

A video display apparatus having a fourth configuration according to the fourth embodiment will be described below. As shown in FIG. 7, the video display apparatus has a 3D image generating module 501 for generating a 3D image from an input 3D image signal according to a display method of a video display unit 506, a 2D image extracting module 202 for extracting, from the input 3D image signal, information that can be viewed as a 2D image, scaling modules 503 and 504 for converting the sizes of the generated 3D image and the extracted 2D image into desired sizes, respectively, an image mixing module 505 for mixing resulting size-converted images into a single image, and the high-resolution video display unit 506 for displaying the image generated by the image mixing module 505. The high-resolution video display unit 506 has a higher resolution than the input 3D image signal.

Next, a description will be made of how the video display apparatus having the configuration of FIG. 7 operates. This configuration is different from the first configuration in that the high-resolution video display unit 506 is employed. If the resolution of a video display unit is the same as that of an input image, to display two images simultaneously, it is necessary to scale images by scaling module before they are mixed together by the image mixing module 505. In contrast, by employing the high-resolution video display unit 506 having the resolution of, for example, two times the resolution of an input image signal, dot-by-dot display can be performed without scaling. With this configuration, when a 3D image signal is input, a stereoscopically-viewable 3D image and a 2D image can be displayed simultaneously. Therefore, plural viewers can view a mixed image simultaneously irrespective of whether or not they use the 3D image selecting module. Since there is no deterioration due to scaling, a viewer can view higher resolution video.

The second configuration and the third configuration can also be combined with a high-resolution video display unit to provide the same advantages as the fourth configuration.

There is provided a modification for each of the first to third embodiments in which the conversion-result image sizes (scaling module) and the arrangement of images in a mixed image (image mixing module) can be set arbitrarily.

Video display apparatus which allow a viewer to view 3D video by displaying, on the display screen, a 3D image that consists of a right-eye image and a left-eye image having a parallax employ a 3D image selecting module that causes only the right-eye image of the 3D image to reach the right eye of the viewer and causes only the left-eye image to reach the left-eye of the viewer. However, in conventional video display apparatus, if the 3D image selecting module is not used, a 3D image is recognized as a double image of a right-eye image and a left-eye image, and cannot be viewed properly. The use of the 3D image selecting module is indispensable, and if the enough number of the 3D image selecting modules is not available, plural viewers cannot view a 3D image simultaneously.

The embodiments allow plural viewers to view same-contents images simultaneously irrespective of whether the 3D image selecting module is used or not by simultaneously displaying a stereoscopically-viewable 3D image and an ordinary 2D image recognizable without using the 3D image selecting module. When a high-resolution video display unit whose resolution is higher than the resolution of an input image signal is employed, no deterioration due to an image size change occurs and a viewer can view higher resolution video.

Conventionally, video display apparatus which allow a viewer to view 3D video using a 3D image selecting module that causes only the right-eye image of the 3D image to reach the right eye of the viewer and causes only the left-eye image to reach the left-eye of the viewer should necessarily employ the 3D image selecting module, an example of which is viewing glasses. And, plural viewers (other than viewer using the 3D image selecting module) cannot view a 3D image simultaneously.

The embodiments, which take the following forms, allow plural viewers to view same-contents images simultaneously irrespective of whether the 3D image selecting module is used or not by simultaneously displaying a stereoscopically-viewable 3D image and an ordinary 2D image recognizable without using the 3D image selecting module.

(1) A video display apparatus, including: a 3D image generating module configured to generate a 3D image from an input 3D image signal according to a display method of a video display unit; a 2D image extracting module configured to extract, from the input 3D image signal, information that can be viewed as a 2D image; two scaling modules configured to convert the sizes of the generated 3D image and the extracted 2D image into desired sizes, respectively; an image mixing module configured to mix resulting size-converted images into a single image; and the video display unit configured to display the image generated by the image mixing module.

(2) The apparatus of item (1), wherein the 2D image extracting module selects and outputs only one of a right-eye image and a left-eye image in the case where the input 3D image is of the side-by-side type.

(3) The apparatus of item (1), wherein the 2D image extracting module outputs a 2D image excluding depth information in the case where the input 3D image consists of a 2D image and the depth information.

(4) A video display apparatus, including: a 2D/3D image converting module configured to generate a 3D image signal from an input 2D image signal; a 3D image generating module configured to generate a 3D image from the generated 3D image signal according to a display method of a video display unit; two scaling modules configured to convert the sizes of the generated 3D image and the input 2D image into desired sizes, respectively; an image mixing module configured to mix resulting size-converted images into a single image; and the video display unit configured to display the image generated by the image mixing module.

(5) A video display apparatus, including: an image selecting module configured to separate a 2D image signal and a 3D image signal from data containing both of a 2D image signal and a 3D image signal having the same contents; a 3D image generating module configured to generate a 3D image from the separated 3D image signal according to a display method of a video display unit; two scaling modules configured to convert the sizes of the generated 3D image and the separated 2D image into desired sizes, respectively; an image mixing module configured to mix resulting size-converted images into a single image; and the video display unit configured to display the image generated by the image mixing module.

(6) A video display apparatus, including: a 3D image generating module configured to generate a 3D image from an input 3D image signal according to a display method of a video display unit; a 2D image extracting module configured to extract, from the input 3D image signal, information that can be viewed as a 2D image; two scaling modules configured to convert the sizes of the generated 3D image and the extracted 2D image into desired sizes, respectively; an image mixing module configured to mix resulting size-converted images into a single image; and the high-resolution video display unit having a higher resolution than the input 3D image signal, configured to display the image generated by the image mixing module.

According to the above-described embodiments, an ordinary 2D image and a 3D image can be displayed simultaneously. One of the first configuration, the second configuration and the third configuration may be selected and employed by judging whether an input image signal is a 3D image signal, a 2D image signal, or a mixture of those signals. For example, metadata of a broadcast or media data may be used in such judgment. For example, an input image signal may be provided not only from the antenna 243 or 248, but also from the network 132 (e.g., CATV, or IP broadcast) or a DVD.

The invention is not limited to the above embodiments, and can be practiced by modifying in various manners without departing from the spirit and scope of the invention. For example, a 2D image and a 3D image may be different contents. Plural 2D images or plural 3D images may be displayed.

Various inventions can be conceived by properly combining plural constituent elements in each embodiment. For example, a part of the constituent elements of each embodiment may be omitted, and constituent elements of different embodiments may be combined as appropriate.

What is claimed is:

1. A video display apparatus, comprising:
a 3D image generating module configured to receive a 3D image input signal; and to generate a 3D image display signal to be displayed on a screen of a video display unit, from the 3D image input signal; and
an image mixing module configured to receive a 2D image signal and the 3D image display signal; to mix the 3D image display signal to be displayed on a first area of the screen and the 2D image signal to be displayed on a second area of the screen to generate a mixed image signal, the first area being different from the second area; and to output the mixed image signal to the video display unit.

2. The apparatus of claim 1, further comprising:
an input module configured to receive an input signal containing the 3D image input signal; and
a 2D image extracting module configured to extract the 2D image signal from the 3D image input signal,
wherein the image mixing module receives the 2D image signal extracted by the 2D image extracting module.

3. The apparatus of claim 1, further comprising;
an input module configured to receive an input signal containing the 2D image signal; and
a 2D/3D image converting module configured to convert the 2D image signal into the 3D image input signal,
wherein the 3D image generating module receives the 3D image input signal converted by the 2D/3D image converting module.

4. The apparatus of claim 1, further comprising:
an input module configured to receive an input signal containing the 2D image signal and the 3D image input signal; and
an image selecting module configured to select and separate the 2D image signal and the 3D image input signal,
wherein the 3D image generating module receives the 3D image input signal selected and separated by the image selecting module, and
wherein the image mixing module receives the 2D image signal selected and separated by the image selecting module

5. The apparatus of claim 1, further comprising:
the video display unit.

6. A video display method, comprising:
receiving a 3D image input signal;
generating a 3D image display signal to be displayed on a screen of a video display unit, from the 3D image input signal;
receiving a 2D image signal and the 3D image display signal;
mixing the 3D image display signal to be displayed on a first area of the screen and the 2D image signal to be displayed on a second area of the screen to generate a mixed image signal, the first area being different from the second area; and
outputting the mixed image signal to the video display unit.
